(19) United States
(12) Patent Application Publication
(10) Pub. No.: US 2011/0098386 A1
(43) Pub. Date: Apr. 28, 2011

(54) PRODUCTS HAVING IMPROVED FLAME RESISTANCE

(75) Inventors: Berit Krauter, Neuss (DE); Hans Franssen, Krefeld (DE); Ute Wollborn, Willich (DE); Michael Wagner, Moers (DE)

(73) Assignee: Bayer MaterialScience AG, Leverkusen (DE)

(21) Appl. No.: 12/868,166

(22) Filed: Aug. 25, 2010

(30) Foreign Application Priority Data
Aug. 28, 2009 (DE) 102009039121.5

(51) Int. Cl. C08K 5/42; C08K 5/3492

(52) U.S. Cl. 524/100; 524/166; 524/165; 524/161

(57) ABSTRACT

The present invention relates to flame-retardant compositions containing:
A. 65 to 99.998 wt. % polycarbonate,
B. 0.001 to 1 wt. % of an organic flame-retardant salt selected from the group consisting of alkali and alkaline-earth salts of aliphatic and aromatic sulfonic acid, sulfonamide and sulfonimide derivatives and mixtures thereof, and
C. 0.001 to 1 wt. % of one or more bromine-containing flame-retardant additives,
   characterised in that that the overall composition contains 100 ppm to 1000 ppm bromine.

### RELATED APPLICATIONS

This application claims benefit to German Patent Application No. 10 2009 039 121.5, filed Aug. 28, 2009, which is incorporated herein by reference in its entirety for all useful purposes.

### BACKGROUND OF THE INVENTION

The present invention relates to compositions containing polycarbonate and 0.001 wt. % to 1.000 wt. % of one or more flame-retardant additives from the class of alkali or alkaline-earth salts of aliphatic or aromatic sulfonic acid, sulfonamide and sulfonimide derivatives and additionally one or more flame-retardant additives from the class of bromine-containing flame-retardant additives, such that the bromine content in the overall composition is 100 ppm to 1000 ppm bromine.

Owing to the excellent properties of plastics, such as for example low density, transparency and strength combined with thermoformability, which ensures a high degree of design freedom, plastics are increasingly superseding metal as a material in many applications. Wherever weight reduction is a priority, above all in aircraft construction, where lightweight materials are preferred, but also in railways or in automotive construction, plastics are increasingly being used. Furthermore, however, plastics are also used in the IT, electrical engineering and electronics sector, where they are used for example as supports for live parts or for the production of television and monitor housings.

Although plastics offer good mechanical and electrical properties for these applications, unlike metals for example they are not however inherently flame resistant, meaning that flame retardants have to be added. Consideration must be given here to the fact that the addition of these flame retardants must not adversely affect the positive mechanical, optical and electrical properties of the plastics that are used.

Combinations of tetrabromobisphenol A oligocarbonate, alkali or alkaline-earth salts of perfluoroalkanesulfonic acids and bisphenol A polycarbonate are described in US 2009/0043023. The bromine-containing flame-retardant additive is used in high concentrations, above 5 wt. %.

WO 2008/125203 A1 describes UV-stabilised polycarbonate moulding compositions containing halogen-containing flame retardants in concentrations requiring a bromine content of >1000 ppm bromine in the overall composition.

U.S. Pat. No. 4,486,560 describes compositions containing between 0.08 and 0.8 wt. % of tri-(2,4,6-tribromophenoxy)triazine in combination with N-(p-tolylsulfonyl)-p-toluenesulfonamide. The combination with further potassium sulfone salts is not described.

JP 11035814 describes compositions containing polycarbonate and optionally thermoplastic polyesters, 0.2 to 20 wt. % of organic halogen-containing compounds and fluorinated polyolefins. The compositions contain no flame-retardant additives from the class of alkali or alkaline-earth salts of aliphatic or aromatic sulfonic acid, sulfonamide and sulfonimide derivatives, however.

Despite all previous efforts, there is still a need for polycarbonate compositions having improved flame resistance, in particular for use in thin-wall products. This is most particularly true in the case of transparent compositions or transparent products, since the addition of flame retardants in the necessary high concentrations often has a negative influence on the optical properties of the compositions and the products produced from them, such as poorer transparency or discolouration of the material, for example.

There is furthermore likewise a demand for polycarbonate compositions with effective flameproofing which have a good viscosity, i.e. melt flowability, as an increasing content of flame retardant generally has a negative influence on the flowability of the compositions.

In this context the object of the present invention was therefore to provide free-flowing, transparent compositions which offer good flame resistance with product wall thicknesses of less than or equal to 3 mm and contain only a small amount of bromine-containing additives.

The object of the present invention is also to provide transparent compositions with polycarbonate, which combine a low bromine content with a good flame-retardant effect and high flowability, without the flame retardants adversely influencing the optical properties of the products produced from the compositions.

### EMBODIMENTS OF THE INVENTION

An embodiment of the present invention is a flame-retardant composition comprising
A) from 65.000 to 99.998 weight % of a polycarbonate;
B) from 0.001 to 1.000 weight % of an organic flame-retardant salt selected from the group consisting of alkali and alkaline-earth salts of aliphatic and aromatic sulfonic acid, sulfonamide and sulfonimide derivatives, and mixtures thereof;
C) from 0.001 to 1.000 weight % of one or more bromine-containing flame-retardant additives;
   wherein the total concentration of bromine in said flame-retardant composition is in the range of from 100 ppm to 1000 ppm.

Another embodiment of the present invention is the above flame-retardant composition, wherein said polycarbonate has an average molecular weight M̅_{w} in the range of from 2000 to 200,000 g/mol.

Another embodiment of the present invention is the above flame-retardant composition, wherein said organic flame-retardant salt is selected from the group consisting of sodium nonafluoro-1-butane sulfonate, potassium nonafluoro-1-butane sulfonate, sodium diphenyl sulfonic acid sulfonate, potassium diphenyl sulfonic acid sulfonate, and mixtures thereof.

Another embodiment of the present invention is the above flame-retardant composition, wherein said organic flame-retardant salt is a mixture of sodium or potassium nonafluoro-1-butane sulfonate and sodium or potassium diphenyl sulfonic acid sulfonate.

Another embodiment of the present invention is the above flame-retardant composition, wherein said sodium or potassium diphenyl sulfonic acid sulfonate and said sodium or potassium nonafluoro-1-butane sulfonate are used in a ratio of from 3:1 to 8:1.

Another embodiment of the present invention is the above flame-retardant composition, wherein said one or more bromine-containing flame-retardant additives is a brominated oligocarbonate.

Another embodiment of the present invention is the above flame-retardant composition, wherein said one or more bromine-containing flame-retardant additives is tetrabromobisphenol A oligocarbonate.

Another embodiment of the present invention is the above flame-retardant composition, wherein said one or more bromine-containing flame-retardant additives is 2,4,6-tris-(2,4,6-tribromophenoxy)-1,3,5-triazine (CAS: 25713-60-4), 1,2-bis(pentabromophenyl)ethane (CAS: 84852-53-9), and/or tribromophenol.

Another embodiment of the present invention is the above flame-retardant composition, wherein said flame-retardant composition further comprises polytetrafluoroethylene or a polytetrafluoroethylene blend as an antidripping agent.

Another embodiment of the present invention is the above flame-retardant composition, wherein the total amount of said organic flame-retardant salt and said one or more bromine-containing flame-retardant additives in said flame-retardant composition is less than 1 weight % and said organic flame-retardant salt is potassium nonafluoro-1-butane sulfonate.

Another embodiment of the present invention is the above flame-retardant composition, wherein said flame-retardant composition further comprises at least one polymer selected from the group consisting of aromatic polycarbonates, aromatic polyesters, polyamides, polyimides, polyester amides, polyacrylates, polymethacrylates, polyacetals, polyurethanes, polyolefins, halogen-containing polymers, polysulfones, polyether sulfones, polyether ketones, polysiloxanes, polybenzimidazoles, urea-formaldehyde resins, melamine-formaldehyde resins, phenol-formaldehyde resins, alkyd resins, epoxy resins, polystyrenes, copolymers of styrene or alpha-methylstyrene with dienes or acrylic derivatives, graft polymers based on graft copolymers based on acrylonitrile/butadiene/styrene or acrylate rubber, and silicone rubbers.

Another embodiment of the present invention is the above flame-retardant composition, wherein said flame-retardant composition further comprises conventional additives selected from the group consisting of fillers, UV stabilisers, heat stabilisers, antistatic agents, pigments, release agents, flow control agents, and combinations thereof.

Yet another embodiment of the present invention is a product comprising the above flame-retardant composition.

Yet another embodiment of the present invention is a moulding for the electrical/electronics sector, a lamp housing, a circuit breaker, a plug connector, a television or monitor housing, a sheet for architectural or industrial glazing systems, or cladding for rail vehicle and aircraft interiors comprising the above flame-retardant composition.

Another embodiment of the present invention is the above moulding, wherein said moulding is produced by injection moulding.

Yet another embodiment of the present invention is a process for producing the above flame-resistant composition, comprising:
a) producing a powder mix comprising a polycarbonate powder, at least one flame-retardant additive selected from the group of perfluorinated sulfonic acid salts, at least one bromine-containing flame retardant, and optionally conventional additives;
b) adding the powder mix from step a) to a further polycarbonate to form a mixture; and
c) extruding the mixture from step b) at a temperature in the range of from 280 to 330° C.

Another embodiment of the present invention is the above process, wherein said further polycarbonate is identical to the polycarbonate used to produce the powder mix in step a).

### DESCRIPTION OF THE INVENTION

The present invention thus relates to compositions containing polycarbonate, 0.001 wt. % to 1.000 wt. % of one or more flame-retardant additives from the class of alkali or alkaline-earth salts of aliphatic or aromatic sulfonic acid, sulfonamide and sulfonimide derivatives, and 0.001 wt. % to 1.000 wt. % of one or more bromine-containing flame-retardant additives, the bromine content in the overall composition being 100 ppm to 1000 ppm.

The compositions advantageously contain no further bromine-containing components and/or additives other than the bromine-containing flame-retardant additives.

The compositions preferably contain no UV stabiliser, the use of which for polymer compositions is known from WO 2008/125203 A1. The compositions are also preferably transparent and have a yellowness index (see page 16 for measurement details) of less than 2.5 and a transmission (see page 16 for measurement details) of over 83.00%.

Flame-retardant additives within the meaning of the present invention are understood to include not only individual flame-retardant additives but also mixtures of two or more different flame-retardant additives.

The compositions of the present invention can be advantageously used in various applications. They include for example applications and mouldings in the electrical/electronics sector, such as for example lamp housings, circuit breakers, plug connectors or television and monitor housings. The compositions according to the invention can moreover also be used in the form of sheets for architectural or industrial glazing systems or as cladding for rail vehicle and aircraft interiors, for which elevated standards of flame resistance are required.

The present invention also relates to processes for producing a composition according to the invention, characterised in that polycarbonate and flame-retardant additive are brought together and mixed. Mixing of the components can also take place in solution, dispersion or suspension, the mixture preferably being homogenised prior to removal of the solvent. The polymer compound thus obtained can be pelletised for example in a further step and then processed directly into mouldings.

Finally the present invention is also directed at products containing a composition of the present invention.

Polycarbonates for the compositions according to the invention are homopolycarbonates, copolycarbonates and thermoplastic, preferably aromatic, polyester carbonates, which in the present application are subsumed under the term “polycarbonate”.

The homopolycarbonates, copolycarbonates and polyester carbonates generally have average molecular weights M̅_{w} (weight average) of 2000 to 200,000, preferably 3000 to 150,000, in particular 5000 to 100,000, most particularly preferably 10,000 to 30,000, in particular 10,000 to 28,000 and most particularly preferably average molecular weights M̅_{w} of 12,000 to 26,000 g/mol (determined by GPC (gel permeation chromatography) with polycarbonate calibration).

Regarding the production of polycarbonates for the compositions according to the invention reference is made here by way of example to Schnell, “Chemistry and Physics of Polycarbonates”, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Morristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718 and finally to Drs. U. Grigo, K. Kircher and P. R. Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, pages 117-299. Production preferably takes place by the interfacial polycondensation process or the melt interesterification process and is described first by reference to the interfacial polycondensation process by way of example.

Preferred compounds to be used as starting compounds are bisphenols of the general formula (1)

HO—Z—OH (1)

wherein Z is a divalent organic radical having 6 to 30 carbon atoms and containing one or more aromatic groups.

Examples of such compounds are bisphenols belonging to the group of dihydroxydiphenyls, bis(hydroxyphenyl)alkanes, indane bisphenols, bis(hydroxyphenyl)ethers, bis(hydroxyphenyl)sulfones, bis(hydroxyphenyl)ketones and α,α′-bis(hydroxyphenyl) diisopropylbenzenes.

Particularly preferred bisphenols belonging to the aforementioned groups of compounds are bisphenol A, tetraalkylbisphenol A, 4,4-(meta-phenylene diisopropyl)diphenol (bisphenol M), 4,4-(para-phenylene diisopropyl)diphenol, N-phenyl isatin bisphenol, 1,1-bis-(4-hydroxyphenyl-3,3,5-trimethylcyclohexane (BP-TMC), bisphenols of the 2-hydrocarbyl-3,3-bis-(4-hydroxyaryl)phthalimidine type, in particular 2-phenyl-3,3-bis-(4-hydroxyphenyl)phthalimidine, and optionally mixtures thereof.

Homopolycarbonates based on bisphenol A and copolycarbonates based on the monomers bisphenol A and 1,1-bis-(4-hydroxyphenyl)-3,3,5-trimethylcyclohexane are particularly preferred. The bisphenol compounds for use according to the invention are reacted with carbonic acid compounds, in particular phosgene, or, in the melt interesterification process, with diphenyl carbonate or dimethyl carbonate.

Polyester carbonates are obtained by reacting the already cited bisphenols, at least one aromatic dicarboxylic acid and optionally carbonic acid equivalents. Suitable aromatic dicarboxylic acids are for example phthalic acid, terephthalic acid, isophthalic acid, 3,3′- or 4,4′-diphenyldicarboxylic acid and benzophenone dicarboxylic acids. A part, up to 80 mol %, preferably from 20 to 50 mol %, of the carbonate groups in the polycarbonates can be replaced by aromatic dicarboxylic acid ester groups.

Inert organic solvents used in the interfacial polycondensation process are for example dichloromethane, the various dichloroethanes and chloropropane compounds, tetrachloromethane, trichloromethane, chlorobenzene and chlorotoluene. Chlorobenzene or dichloromethane or mixtures of dichloromethane and chlorobenzene are preferably used.

The interfacial polycondensation reaction can be accelerated by means of catalysts such as tertiary amines, in particular N-alkyl piperidines or onium salts. Tributylamine, triethylamine and N-ethylpiperidine are preferably used. In the case of the melt interesterification process the catalysts cited in DE-A 42 38 123 are used.

The polycarbonates can be branched in an intentional and controlled manner through the use of small amounts of branching agents. Some suitable branching agents are: isatin bis-cresol, phloroglucinol, 4,6-dimethyl-2,4,6-tri-(4-hydroxyphenyl)heptene-2; 4,6-dimethyl-2,4,6-tri-(4-hydroxyphenyl)heptane; 1,3,5-tri-(4-hydroxyphenyl)benzene; 1,1,1-tri-(4-hydroxyphenyl)ethane; tri-(4-hydroxyphenyl)phenylmethane; 2,2-bis-[4,4-bis-(4-hydroxyphenyl)cyclohexyl]propane; 2,4-bis-(4-hydroxyphenyl isopropyl)phenol; 2,6-bis-(2-hydroxy-5′-methylbenzyl)-4-methylphenol; 2-(4-hydroxyphenyl)-2-(2,4-dihydroxyphenyl)propane; hexa-(4-(4-hydroxyphenyl isopropyl)phenyl)ortho-terephthalic acid ester; tetra-(4-hydroxyphenyl)methane; tetra-(4-(4-hydroxyphenyl isopropyl)phenoxy)methane; α,α′,α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)methyl)benzene and in particular: 1,1,1-tri-(4-hydroxyphenyl)ethane and bis-(3-methyl-4-hydroxyphenyl)-2-oxo-2,3-dihydroindole.

The 0.05 to 2 mol %, relative to diphenols used, of branching agents or mixtures of branching agents which can optionally be used can be used together with the diphenols or also added at a later stage of the synthesis.

Chain terminators can be used. Phenols such as phenol, alkyl phenols such as cresol and 4-tert-butyl phenol, chlorophenol, bromophenol, cumyl phenol or mixtures thereof, in amounts of 1-20 mol %, preferably 2-10 mol %, per mol of bisphenol, are preferably used as chain terminators. Phenol, 4-tert-butyl phenol and cumyl phenol are preferred.

Chain terminators and branching agents can be added to the synthesis separately or together with the bisphenol.

The preferred polycarbonate according to the invention is bisphenol A homopolycarbonate.

The polycarbonates according to the invention can also be produced by the melt interesterification process as an alternative. The melt interesterification process is described for example in Encyclopedia of Polymer Science, Vol. 10 (1969), Chemistry and Physics of Polycarbonates, Polymer Reviews, H. Schnell, Vol. 9, John Wiley and Sons, Inc. (1964) and DE-B 10 31 512.

In the melt interesterification process the aromatic dihydroxy compounds already described in connection with the interfacial polycondensation process are interesterified in the melt with carbonic acid diesters with the aid of suitable catalysts and optionally further additives.

Carbonic acid diesters within the meaning of the invention are those of formulae (2) and (3)

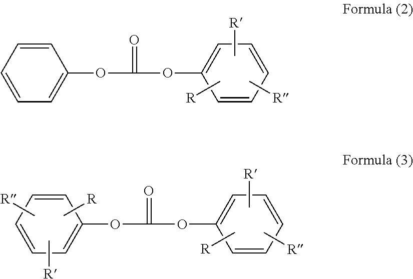

wherein
R, R′ and R″ can independently of one another denote H, optionally branched C₁-C₃₄ alkyl/cycloalkyl, C₇-C₃₄ alkaryl or C₆-C₃₄ aryl,
for example
diphenyl carbonate, butylphenyl phenyl carbonate, dibutylphenyl carbonate, isobutylphenyl phenyl carbonate, diisobutylphenyl carbonate, tert-butylphenyl phenyl carbonate, di-tert-butylphenyl carbonate, n-pentylphenyl phenyl carbonate, di-(n-pentylphenyl) carbonate, n-hexylphenyl phenyl carbonate, di-(n-hexylphenyl) carbonate, cyclohexylphenyl phenyl carbonate, dicyclohexylphenyl carbonate, phenylphenol phenyl carbonate, diphenylphenol carbonate, isooctylphenyl phenyl carbonate, diisooctylphenyl carbonate, n-nonylphenyl phenyl carbonate, di-(n-nonylphenyl) carbonate, cumylphenyl phenyl carbonate, dicumylphenyl carbonate, naphthylphenyl phenyl carbonate, dinaphthyl phenyl carbonate, di-tert-butylphenyl phenyl carbonate, di-(di-tert-butylphenyl) carbonate, dicumylphenyl phenyl carbonate, di-(dicumylphenyl) carbonate, 4-phenoxyphenyl phenyl carbonate, di-(4-phenoxyphenyl) carbonate, 3-pentadecylphenyl phenyl carbonate, di-(3-pentadecylphenyl) carbonate, tritylphenyl phenyl carbonate, ditritylphenyl carbonate,
preferably
diphenyl carbonate, tert-butylphenyl phenyl carbonate, di-tert-butylphenyl carbonate, diphenylphenol carbonate, cumylphenyl phenyl carbonate, diphenylphenol phenyl carbonate, cumylphenyl carbonate, particularly preferably diphenyl carbonate.

Mixtures of the cited carbonic acid diesters can also be used.

The proportion of carbonic acid esters is 100 to 130 mol %, preferably 103 to 120 mol %, particularly preferably 103 to 109 mol %, relative to the dihydroxy compound.

Basic catalysts, such as for example alkali and alkaline-earth hydroxides and oxides but also ammonium or phosphonium salts, hereinafter referred to as onium salts, as described in the cited literature are used in the melt interesterification process as catalysts within the meaning of the invention. Onium salts are preferably used here, particularly preferably phosphonium salts. Phosphonium salts within the meaning of the invention are those of formula (4)

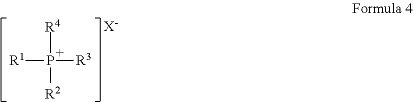

wherein
R¹⁻⁴ can be identical or different C₁-C₁₀ alkyls, C₆-C₁₀ aryls, C₇-C₁₀ aralkyls or C₅-C₆ cycloalkyls, preferably methyl, or C₆-C₁₄ aryls, particularly preferably methyl or phenyl, and
X⁻ can be an anion such as hydroxide, sulfate, hydrogen sulfate, hydrogen carbonate, carbonate, a halide, preferably chloride, or an alcoholate of the formula OR, wherein R can be C₆-C₁₄ aryl or C₇-C₁₂ aralkyl, preferably phenyl. Preferred catalysts are tetraphenyl phosphonium chloride, tetraphenyl phosphonium hydroxide, tetraphenyl phosphonium phenolate, and particularly preferably tetraphenyl phosphonium phenolate.

The catalysts are preferably used in amounts from 10⁻⁸ to 10⁻³ mol, relative to one mol of bisphenol, particularly preferably in amounts from 10⁻⁷ to 10⁻⁴ mol.

Further catalysts can be used alone or optionally in addition to the onium salt to increase the rate of polymerisation. These include salts of alkali metals and alkaline-earth metals, such as hydroxides, alkoxides and aryloxides of lithium, sodium and potassium, preferably hydroxide, alkoxide or aryloxide salts of sodium. Sodium hydroxide and sodium phenolate are most preferred.

The amounts of co-catalyst can be in the range from 1 to 200 ppb, preferably 5 to 150 ppb and most preferably 10 to 125 ppb, calculated in each case as sodium.

The interesterification reaction of the aromatic dihydroxy compound and the carbonic acid diester in the melt is preferably performed in two stages. In the first stage the aromatic dihydroxy compound and the carbonic acid diester are melted at temperatures of 80 to 250° C., preferably 100 to 230° C., particularly preferably 120 to 190° C., under normal pressure in 0 to 5 hours, preferably 0.25 to 3 hours. After adding the catalyst the oligocarbonate is produced from the aromatic dihydroxy compound and the carbonic acid diester by applying a vacuum (up to a pressure of 2.6 mbar in the apparatus) and raising the temperature (to up to 260° C.) by distilling off the monophenol. Most of it is formed as process vapours. The oligocarbonate produced in this way has an weight-average molecular weight Mw (determined by measuring the relative solution viscosity in dichloromethane or in mixtures of equal amounts by weight of phenol/o-dichlorobenzene, calibrated by light scattering) in the range from 2000 g/mol to 18,000 g/mol, preferably 4000 g/mol to 15,000 g/mol.

In the second stage the polycarbonate is produced by polycondensation by further increasing the temperature to 250 to 320° C., preferably 270 to 295° C., under a pressure of <2.6 mbar, the residual process vapours being removed.

The catalysts can also be used in combination (two or more) with one another.

If alkali metal/alkaline-earth metal catalysts are used, the alkali metal/alkaline-earth metal catalysts are preferably added later on (for example after oligocarbonate synthesis during polycondensation in the second stage).

Within the meaning of the process according to the invention the reaction of the aromatic dihydroxy compound and the carbonic acid diester to the polycarbonate can be performed batchwise or preferably continuously, for example in stirred-tank reactors, film evaporators, falling-film evaporators, series of stirred-tank reactors, extruders, compounders, simple disc reactors and high-viscosity disc reactors.

Branched polycarbonates or copolycarbonates can be produced by using polyfunctional compounds, in an analogous manner to the interfacial polycondensation process.

Further aromatic polycarbonates and/or other plastics such as aromatic polyesters, such as polybutylene terephthalate or polyethylene terephthalate, polyamides, polyimides, polyester amides, polyacrylates and polymethacrylates, such as for example polyalkyl (meth)acrylates and here in particular polymethyl methacrylate, polyacetals, polyurethanes, polyolefins, halogen-containing polymers, polysulfones, polyether sulfones, polyether ketones, polysiloxanes, polybenzimidazoles, urea-formaldehyde resins, melamine-formaldehyde resins, phenol-formaldehyde resins, alkyd resins, epoxy resins, polystyrenes, copolymers of styrene or alpha-methylstyrene with dienes or acrylic derivatives, graft polymers on the basis of graft copolymers based on acrylonitrile/butadiene/styrene or acrylate rubber (see for example the graft polymers described in EP-A 640 655) or silicone rubbers can also be added to the polycarbonates according to the invention in a known manner, for example by compounding.

Conventional additives for these thermoplastics, such as fillers, UV stabilisers, heat stabilisers, antistatic agents and pigments, can also be added in the conventional quantities to the polycarbonates according to the invention and to the further plastics which are optionally included; the demoulding behaviour and/or flow properties can optionally also be improved by the addition of external release agents and/or flow control agents (e.g. alkyl and aryl phosphites, phosphates, phosphanes, low-molecular-weight carboxylic acid esters, halo compounds, salts, chalk, silica flour, glass and carbon fibres, pigments and combinations thereof).

Such compounds are described for example in WO 99/55772 A1, p. 15-25, EP 1 308 084 and in the corresponding chapters of “Plastics Additives Handbook”, ed. Hans Zweifel, 5^{th} Edition 2000, Hanser Publishers, Munich.

Suitable flame retardants within the meaning of the present invention are inter alia alkali or alkaline-earth salts of aliphatic or aromatic sulfonic acid, sulfonamide and sulfonimide derivatives, for example potassium perfluorobutane sulfonate, potassium diphenyl sulfone sulfonate, N-(p-tolylsulfonyl)-p-toluene sulfimide potassium salt, N—(N′-benzylaminocarbonyl) sulfanylimide potassium salt.

Salts which are preferably used as flame retardants in the moulding compositions according to the invention are selected from the group comprising sodium or potassium perfluorobutane sulfate, sodium or potassium perfluoromethane sulfonate, sodium or potassium perfluorooctane sulfate, sodium or potassium-2,5-dichlorobenzene sulfate, sodium or potassium-2,4,5-trichlorobenzene sulfate, sodium or potassium methyl phosphonate, sodium or potassium-(2-phenylethylene) phosphonate, sodium or potassium pentachlorobenzoate, sodium or potassium-2,4,6-trichlorobenzoate, sodium or potassium-2,4-dichlorobenzoate, lithium phenyl phosphonate, sodium or potassium diphenyl sulfone sulfonate, sodium or potassium-2-formylbenzene sulfonate, sodium or potassium-(N-benzene sulfonyl) benzene sulfonamide, trisodium or tripotassium hexafluorooaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium or lithium phosphate, N-(p-tolylsulfonyl)-p-toluene sulfimide potassium salt, N—(N′-benzyl aminocarbonyl) sulfanylimide potassium salt and mixtures thereof.

Sodium or potassium perfluorobutane sulfate, sodium or potassium perfluorooctane sulfate, sodium or potassium diphenyl sulfone sulfonate and sodium or potassium-2,4,6-trichlorobenzoate and N-(p-tolylsulfonyl)-p-toluene sulfimide potassium salt, N—(N′-benzyl aminocarbonyl) sulfanylimide potassium salt are more preferably used.

In a preferred embodiment the organic flame-retardant salt is selected from the group consisting of sodium or potassium nonafluoro-1-butane sulfonate, sodium or potassium diphenyl sulfonic acid sulfonate and mixtures thereof, a mixture of potassium salts being particularly preferred.

The ratio of sodium or potassium diphenyl sulfonic acid sulfonate and sodium or potassium nonafluoro-1-butane sulfonate is by preference 3:1 to 8:1, preferably 4:1 to 7:1, and particularly preferably approximately 6:1.

Potassium nonafluoro-1-butane sulfonate and sodium or potassium diphenyl sulfone sulfonate are particularly preferred as the flame-retardant salt. Potassium nonafluoro-1-butane sulfonate is commercially available inter alia as Bayowet® C4 (Lanxess, Leverkusen, Germany, CAS No. 29420-49-3), RM64 (Miteni, Italy) or as 3M™ Perfluorobutanesulfonyl Fluoride FC-51 (3M, USA).

Potassium diphenyl sulfonate is commercially available from for example Sloss Industries Corp under the name KSS-FR.

Other mixtures of the aforementioned salts are likewise suitable.

The organic flame-retardant salts are used in the moulding compositions in amounts of 0.001 wt. % to 1.000 wt. %, preferably 0.01 wt. % to 0.80 wt. %, particularly preferably 0.01 wt. % to 0.60 wt. %, in particular 0.03 wt. % to 0.20 wt. %, relative in each case to the overall composition.

Other suitable flame retardants within the meaning of the present invention are bromine-containing compounds. These include brominated compounds such as brominated oligocarbonates (e.g. tetrabromobisphenol A oligocarbonate BC-52® (CAS No. 94334-64-2), a phenoxy-terminated carbonate oligomer of tetrabromobisphenol A with a bromine content of 52%, a melting range from 180° C. to 210° C. and a specific density of 2.2 g/ml (determined at 25° C.); BC-58® (CAS No. 71342-77-3), a phenoxy-terminated carbonate oligomer of tetrabromobisphenol A with a bromine content of 58%, a melting range from 200° C. to 230° C. and a specific density of 2.2 g/ml (determined at 25° C.); BC-52HP® (CAS No. 94334-64-2), phenoxy-terminated carbonate oligomer of tetrabromobisphenol A from Chemtura with a bromine content of 53.9%, a melting range from 210° C. to 240° C. and a specific density of 2.2 g/ml (determined at 25° C.), polypentabromobenzyl acrylates (e.g. FR 1025 from Dead Sea Bromine (DSB)); oligomeric reaction products of tetrabromobisphenol A with epoxides (e.g. F 2300 from Dead Sea Bromine, CAS No. 68928-70-1, bromine content 51%, average molecular weight Mw=3600 and F 2400, CAS No. 68928-70-1, bromine content 52-54%, average molecular weight Mw=40,000 to 60,000); 2,4,6-tribromophenol (CAS No. 118-79-6) with the trade name: FR-613, FR 20, Solaris FR 20, PH-73, PH-73FF, available from Sinobrom, Chemtura, Manac, Shandong Laizhou, Shandong Ocean, Shouguang Ocean, Solaris ChemTech, Weifang Dacheng or ICL-IP; or brominated oligostyrenes or polystyrenes (e.g. Pyro-Chek® 68PB from Ferro Corporation; PDBS 80 and Firemaster® PBS-64HW from Chemtura and 2,4,6-tris-(2,4,6-tribromophenoxy)-1,3,5-triazine (CAS: 25713-60-4) (e.g. FR245 from ICL, or PYROGUARD SR-245 available from Dai-Ichi Kogyo Seiyaku Co., Ltd) and 1,2-bis(pentabromophenyl)ethane (CAS: 84852-53-9) (e.g. Firemaster 2100 from Chemtura, or Saytex 8010 from Albemarle).

Mixtures of the cited brominated compounds are likewise suitable.

Particularly preferred brominated flame-retardant compounds within the context of this invention are the following commercially available products:
tetrabromobisphenol A oligocarbonate BC-52HP® (CAS No. 94334-64-2), phenoxy-terminated carbonate oligomer of tetrabromobisphenol A with a bromine content of 53.9%, a melting range from 210° C. to 240° C. and a specific density of 2.2 g/ml (determined at 25° C.) from Chemtura,
1,2-bis(pentabromophenyl)ethane Saytex 8010® (CAS: 84852-53-9) with a bromine content of 82.27%, a melting point of 350° C. and a specific density of 3.25 (measured at 25° C.), and
2,4,6-tris-(2,4,6-tribromophenoxy)-1,3,5-triazine FR 245® (CAS: 25713-60-4) with a bromine content of 67.37%, a melting point of 230° C. and a specific density of 2.44 g/ml (determined at 25° C.).

Brominated oligocarbonates, in particular those based on tetrabromobisphenol A oligocarbonate, are particularly preferred.

The proportion of bromine-containing compounds in the compositions is 0.001 wt. % to 1.000 wt. %, preferably 0.01 wt. % to 0.80 wt. %, and particularly preferably 0.1 wt. % to 0.6 wt. %, the bromine content in the overall composition being 100 ppm to 1000 ppm, preferably 200 ppm to 950 ppm and particularly preferably 300 ppm to 900 ppm, and most preferably 600 ppm to 900 ppm.

Polytetrafluoroethylene (PTFE), preferably as a powder or as a blend, can additionally be added to the moulding compositions as an antidripping agent. These are commercially available in various product grades. They include additives such as Hostaflon® TF2021 but also PTFE blends such as Metablen® A-3800 (approx. 40% PTFE CAS 9002-84-0 and approx. 60% methyl methacrylate/butyl acrylate copolymer CAS 25852-37-3 from Mitsubishi-Rayon) or Blendex® B449® (approx. 50% PTFE and approx. 50% SAN [consisting of 80% styrene and 20% acrylonitrile] from Chemtura.

Within the context of the present invention PTFE is used in amounts of 0.05 wt. % to 5.00 wt. %, preferably 0.1 wt. % to 1.0 wt. %, particularly preferably 0.1 wt. % to 0.5 wt. %, relative in each case to the overall composition and to the pure PTFE content.

A particularly preferred embodiment contains organic flame-retardant salt and bromine-containing flame-retardant additive in the sum of parts by weight relative to the overall composition of less than 1 wt. %, the organic flame-retardant salt being preferably potassium nonafluoro-1-butane sulfonate.

### Production of the Compositions:

Production of a composition containing polycarbonate and flame-retardant additives takes place with conventional mixing processes and can take place for example by mixing solutions of flame-retardant additives with a solution of polycarbonate in suitable solvents such as dichloromethane, haloalkanes, halogen aromatics, chlorobenzene and xylenes. The mixtures of substances are then preferably homogenised in the known manner by extrusion. The mixtures of solutions are preferably processed, for example compounded, in the known manner by evaporation of the solvent and subsequent extrusion.

The composition can additionally be mixed in conventional mixing devices such as extruders (for example twin-screw extruders), compounders, Brabender or Banbury mills, and then extruded. Following extrusion the extrudate can be cooled and shredded. Individual components can also be premixed and then the remaining starting materials added individually and/or likewise in a mixture.

The compositions according to the invention can be processed in a manner known to the person skilled in the art and converted into any type of mouldings, for example by extrusion, injection moulding or extrusion blow moulding.

In the production of sheets according to the present invention the polycarbonate pellets of the base material are fed to the feed hopper of the main extruder and the coextrusion material to that of the coextruder. Each material is melted and transported in the respective cylinder/screw plasticising system. The two material melts are brought together in the coex adapter and after leaving the nozzle and being cooled they form a composite. The additional equipment serves to transport, cut to length and stack the extruded sheets.

Sheets without a coextruded layer are produced in the corresponding manner, either by not running the coextruder or by filling it with the same polymer composition as the main extruder.

Blow moulding of polycarbonate is described in more detail inter alia in DE 102 29 594 and in the literature cited therein.

### Flameproofing Tests

Many different flameproofing tests are known. In the present case the flame resistance of plastics is determined by means of the UL94V method (see in this regard:
a) Underwriters Laboratories Inc. Standard of Safety, “Test for Flammability of Plastic Materials for Parts in Devices and Appliances”, p. 14 ff, Northbrook 1998;
b) J. Troitzsch, “International Plastics Flammability Handbook”, p. 346 ff, Hanser Verlag, Munich 1990)

The burning times and dripping behaviour of ASTM standard test pieces are evaluated.

In order for a flameproofed plastic to be given a flammability rating of UL94V-0, the following detailed criteria must be met: with a set of 5 ASTM standard test pieces (dimensions: 127×12.7×X mm³, where X=the thickness of the test piece, e.g. 3.2, 3.0, 1.5, 1.0 or 0.75 mm), after being ignited twice for a period of 10 seconds all samples may continue to burn with an open flame of a defined height for no longer than 10 seconds. The sum of the burning times for 10 ignitions of 5 samples must not exceed 50 seconds. Furthermore, no burning material may fall, the test piece must not burn away completely, and the test piece must not continue to glow for longer than 30 seconds. The rating UL94V-1 requires the individual test pieces to keep on burning for no longer than 30 seconds and the sum of the burning times for 10 ignitions of 5 samples not to exceed 250 seconds. The overall glowing time must not exceed 250 seconds. The other criteria are identical to those mentioned above. The samples are given the rating of UL94V-2 if the criteria of UL94V-1 are met but burning material falls.

### Rheological Properties:

The melt flow rate (MFR, MVR) is determined in accordance with ASTM D1238 MVR.

### Optical Measurements:

The haze and transmission were measured on sheets measuring 60×40×4 mm³ in accordance with ISO 13468.

The yellowness index (YI) is calculated in accordance with ASTM E313.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Production of the Compositions

The compositions according to the present invention are compounded in a device comprising a metering unit for the components, a co-rotating twin-screw compounder (ZSK 25 from Werner & Pfleiderer) having a screw diameter of 25 mm, a perforated nozzle for extruding the melt strands, a water bath for cooling and solidifying the strands, and a pelletiser.

For the production of the compositions of examples 1 to 12 in the compounding equipment described above, the following components were used:

Makrolon® 2408 is a polycarbonate which is commercially available from Bayer MaterialScience AG. Makrolon® 2408 is EU/FDA grade and contains no UV absorber. The melt volume-flow rate (MVR) as defined in ISO 1133 is 19 cm³/(10 min) at 300° C. and under a load of 1.2 kg.
Irganox® 1076 (CAS: 2082-79-3) is a monofunctional, sterically hindered phenol which is commercially available from Ciba AG and which belongs to the group of phenolic antioxidants.
Irgafos® P-EPQ FF (CAS: 119345-01-6) is a phosphinite which is commercially available from Ciba AG.
Loxiol VPG® 861 is a pentaerythritol tetrastearate which is commercially available from Cognis AG.
KSS is a potassium diphenyl sulfone sulfonate which is commercially available from Sloss Industries.
C4, Bayowet® C4 is a potassium nonafluoro-1-butane sulfonate which is commercially available from Lanxess AG.
FR245 is a 2,4,6-tris-(2,4,6-tribromophenoxy)-1,3,5-triazine (CAS: 25713-60-4) which is commercially available from ICL-IP. FR245 contains 67.37% bromine.
S8010, Saytex® 8010 is a bis(pentabromophenyl)ethane (CAS: 84852-53-9) which is commercially available from Albemarle. According to the manufacturer's information Saytex® 8010 contains 82.27% bromine.
BC52, BC-52HP® is a phenoxy-terminated tetrabromobisphenol A carbonate oligomer which is commercially available from Chemtura. According to the manufacturer's information BC-52 HP contains 53.9% bromine.

The compounds of examples 1 to 12 are produced by adding a 10 wt. % powder mix of Makrolon® 2408 powder with 0.01 wt. % Irganox 1076, 0.04 wt. % Irgafos P-EPQ FF, 0.4 wt. % PETS and the amount specified in the examples of the cited flame-retardant additives from the group of sulfonic acid salts according to the invention (KSS, C4) and the bromine-containing flame-retardant additives (i.e. 0.01 wt. % Irganox® 1076, 0.04 wt. % Irgafos® P-EPQ FF, 0.40 wt. % PETS and the amount specified in the table of the cited flame-retardant additives from the group of sulfonic acid salts according to the invention (KSS, C4) and the bromine-containing flame-retardant additives are added with Makrolon® 2408 powder to obtain 10.00 wt. % of the total composition) to 90 wt. % Makrolon® 2408 pellets, to produce the mixtures (compounds) specified in the examples, the figures in wt. % adding to 100% and being stated relative to the weight of the overall composition.

The compounds of examples 1 to 12 are then processed into test pieces measuring 127×12.7×D mm³ (D [thickness in mm]=3.0 and 2.8) for flameproofing measurements and 60×40×4 mm³ for optical measurements, using an Arburg Allrounder 270S-500-60 having a screw diameter of 18 mm.

| | Compounds from | |
|---|---|---|
| Process parameters | examples 1 to 12 | |
| Extruder heating zones | | |
| Extruder Z1 | 290° | C. |
| Extruder Z2 | 295° | C. |
| Extruder Z3 | 300° | C. |
| Extruder Z4 | 300° | C. |
| Die temperature | 95° | C. |
| Injection pressure | 1600 | bar |
| (max) | | |
| Holding pressure | 1200 | bar |
| (support point 1) | | |
| Holding pressure | 1000 | bar |
| (support point 2) | | |
| Holding pressure | 800 | bar |
| (support point 3) | | |
| Back pressure | 100 | bar |

The flameproofing test was conducted in accordance with UL 94V. Two sets of 5 UL test pieces (a total of 10 UL test pieces being tested) were measured in accordance with UL94V, with one set being measured after being stored for 48 hours in 50% relative humidity at 23° C., the other set being measured after being stored for 7 days at 70° C. in a hot-air oven.

### EXAMPLES

| | | Examples: | | | | | |
|---|---|---|---|---|---|---|---|
| | | Cmp 1 | 2 | 3 | 4 | Cmp 5 | 6 |
| Potassium diphenyl sulfone sulfonate | | 0.40 | 0.40 | 0.40 | 0.40 | — | — |
| (KSS) in wt. % | | | | | | | |
| Potassium nonafluoro-1-butane | | 0.065 | 0.065 | 0.065 | 0.065 | 0.065 | 0.065 |
| sulfonate (C4) in wt. % | | | | | | | |
| Br source | | — | FR 245 | Saytex | BC52 | — | FR 245 |
| | | | | 8010 | | | |
| Content of bromine-containing flame- | | — | 0.13 | 0.10 | 0.16 | — | 0.13 |
| retardant additive in wt. % | | | | | | | |
| Bromine content (overall composition) | | — | 0.088 | 0.082 | 0.086 | — | 0.088 |
| in wt. % * | | | | | | | |
| MVR | | 17.73 | 17.79 | 17.82 | 17.75 | 17.39 | 17.80 |
| UL94V at 3.0 mm | No. V0 ** | 6 | 8 | 8 | 10 | 7 | 10 |
| | No. V1 | 1 | 0 | 0 | 0 | 1 | 0 |
| | No. V2 | 3 | 2 | 2 | 0 | 2 | 0 |
| | No. V n.d. | 0 | 0 | 0 | 0 | 0 | 0 |
| UL94V at 2.8 mm | No. V0 | 3 | 7 | 8 | 10 | 6 | 7 |
| | No. V1 | 1 | 1 | 0 | 0 | 0 | 3 |
| | No. V2 | 6 | 2 | 2 | 0 | 4 | 0 |
| | No. V n.d. | 0 | 0 | 0 | 0 | 0 | 0 |
| Haze | % | 8.07 | 6.40 | 7.79 | 8.02 | 4.7 | 3.63 |
| Transmission | % | 82.84 | 83.29 | 83.14 | 83.03 | 84.1 | 84.37 |
| YI | | 3.16 | 2.56 | 2.72 | 2.77 | 2.2 | 2.03 |
| | | Examples: | | | | | |
| | | 7 | 8 | Cmp 9 | 10 | 11 | 12 |
| Potassium diphenyl sulfone sulfonate | | — | | 0.40 | 0.40 | 0.40 | 0.40 |
| (KSS) in wt. % | | | | | | | |
| Potassium nonafluoro-1-butane | | 0.065 | 0.065 | — | — | — | — |
| sulfonate (C4) in wt. % | | | | | | | |
| Br source | | Saytex | BC52 | — | FR 245 | Saytex | BC52 |
| | | 8010 | | | | 8010 | |
| Content of bromine-containing flame- | | 0.10 | 0.16 | — | 0.13 | 0.10 | 0.16 |
| retardant additive in wt. % | | | | | | | |
| Bromine content (overall composition) | | 0.082 | 0.086 | — | 0.088 | 0.082 | 0.086 |
| in wt. % * | | | | | | | |
| MVR | | 17.94 | 17.28 | 17.30 | 18.06 | 17.51 | 17.45 |
| UL94V at 3.0 mm | No. V0 ** | 10 | 7 | 4 | 10 | 8 | 8 |
| | No. V1 | 0 | 0 | 0 | 0 | 0 | 0 |
| | No. V2 | 0 | 3 | 6 | 0 | 2 | 2 |
| | No. V n.d. | 0 | 0 | 0 | 0 | 0 | 0 |
| UL94V at 2.8 mm | No. V0 | 8 | 6 | 5 | 6 | 8 | 6 |
| | No. V1 | 0 | 1 | 0 | 0 | 0 | 0 |
| | No. V2 | 2 | 3 | 5 | 4 | 2 | 4 |
| | No. V n.d. | 0 | 0 | 0 | 0 | 0 | 0 |
| Haze | % | 2.66 | 4.0 | 3.58 | 6.10 | 6.32 | 4.21 |
| Transmission | % | 84.65 | 84.2 | 83.91 | 83.86 | 83.74 | 84.14 |
| YI | | 1.78 | 2.1 | 2.03 | 2.31 | 2.47 | 1.70 |

* theoretically calculated bromine content according to manufacturer's information
** the ratings V0 to V2 and n.d. correspond to the UL94V ratings

As is clear from the table, the compositions of the present invention 2 to 4, 6 to 8, 10 to 12 exhibit a significantly improved flameproofing as compared with the comparative examples Cmp 1, Cmp 5 and Cmp 9, despite containing a smaller amount of flame retardant, in particular with the smaller test piece thickness, without there being a negative influence on the melt flowability. Examples 2 to 4 and 6 to 8 also exhibit a clear improvement in the YI.

1. A flame-retardant composition comprising
A) from 65.000 to 99.998 weight % of a polycarbonate;
B) from 0.001 to 1.000 weight % of an organic flame-retardant salt selected from the group consisting of alkali and alkaline-earth salts of aliphatic and aromatic sulfonic acid, sulfonamide and sulfonimide derivatives, and mixtures thereof;
C) from 0.001 to 1.000 weight % of one or more bromine-containing flame-retardant additives;
wherein the total concentration of bromine in said flame-retardant composition is in the range of from 100 ppm to 1000 ppm.

2. The flame-retardant composition of claim 1, wherein said polycarbonate has an average molecular weight M̅_{w} in the range of from 2000 to 200,000 g/mol.

3. The flame-retardant composition of claim 1, wherein said organic flame-retardant salt is selected from the group consisting of sodium nonafluoro-1-butane sulfonate, potassium nonafluoro-1-butane sulfonate, sodium diphenyl sulfonic acid sulfonate, potassium diphenyl sulfonic acid sulfonate, and mixtures thereof.

4. The flame-retardant composition of claim 1, wherein said organic flame-retardant salt is a mixture of sodium or potassium nonafluoro-1-butane sulfonate and sodium or potassium diphenyl sulfonic acid sulfonate.

5. The flame-retardant composition of claim 4, wherein said sodium or potassium diphenyl sulfonic acid sulfonate and said sodium or potassium nonafluoro-1-butane sulfonate are used in a ratio of from 3:1 to 8:1.

6. The flame-retardant composition of claim 1, wherein said one or more bromine-containing flame-retardant additives is a brominated oligocarbonate.

7. The flame-retardant composition of claim 1, wherein said one or more bromine-containing flame-retardant additives is tetrabromobisphenol A oligocarbonate.

8. The flame-retardant composition of claim 1, wherein said one or more bromine-containing flame-retardant additives is 2,4,6-tris-(2,4,6-tribromophenoxy)-1,3,5-triazine (CAS: 25713-60-4), 1,2-bis(pentabromophenyl)ethane (CAS: 84852-53-9), and/or tribromophenol.

9. The flame-retardant composition of claim 1, wherein said flame-retardant composition further comprises polytetrafluoroethylene or a polytetrafluoroethylene blend as an antidripping agent.

10. The flame-retardant composition of claim 1, wherein the total amount of said organic flame-retardant salt and said one or more bromine-containing flame-retardant additives in said flame-retardant composition is less than 1 weight % and said organic flame-retardant salt is potassium nonafluoro-1-butane sulfonate.

11. The flame-retardant composition of claim 1, wherein said flame-retardant composition further comprises at least one polymer selected from the group consisting of aromatic polycarbonates, aromatic polyesters, polyamides, polyimides, polyester amides, polyacrylates, polymethacrylates, polyacetals, polyurethanes, polyolefins, halogen-containing polymers, polysulfones, polyether sulfones, polyether ketones, polysiloxanes, polybenzimidazoles, urea-formaldehyde resins, melamine-formaldehyde resins, phenol-formaldehyde resins, alkyd resins, epoxy resins, polystyrenes, copolymers of styrene or alpha-methylstyrene with dienes or acrylic derivatives, graft polymers based on acrylonitrile/butadiene/styrene or acrylate rubber, and silicone rubbers.

12. The flame-retardant composition of claim 1, wherein said flame-retardant composition further comprises conventional additives selected from the group consisting of fillers, UV stabilisers, heat stabilisers, antistatic agents, pigments, release agents, flow control agents, and combinations thereof.

13. A product comprising the flame-retardant composition of claim 1.

14. A moulding for the electrical/electronics sector, a lamp housing, a circuit breaker, a plug connector, a television or monitor housing, a sheet for architectural or industrial glazing systems, or cladding for rail vehicle and aircraft interiors comprising the flame-retardant composition of claim 1.

15. The moulding of claim 14, wherein said moulding is produced by injection moulding.

16. A process for producing the flame-resistant composition of claim 1, comprising:
a) producing a powder mix comprising a polycarbonate powder, at least one flame-retardant additive selected from the group of perfluorinated sulfonic acid salts, at least one bromine-containing flame retardant, and optionally conventional additives;
b) adding the powder mix from step a) to a further polycarbonate to form a mixture; and
c) extruding the mixture from step b) at a temperature in the range of from 280 to 330° C.

17. The process of claim 16, wherein said further polycarbonate is identical to the polycarbonate used to produce the powder mix in step a).
